(19) United States
(12) Patent Application Publication
(10) Pub. No.: US 2026/0001513 A1
(43) Pub. Date: Jan. 1, 2026

(54) WIPER DEVICE

(71) Applicant: MITSUBA Corporation, Gunma (JP)

(72) Inventor: TOSHIYUKI AMAGASA, Gunma (JP)

(73) Assignee: MITSUBA Corporation, Gunma (JP)

(21) Appl. No.: 19/230,024

(22) Filed: Jun. 5, 2025

(30) Foreign Application Priority Data
Jun. 27, 2024 (JP) 2024-103948

(51) Int. Cl. B60S 1/08

(52) U.S. Cl. CPC B60S 1/0814

(57) ABSTRACT

A wiper device includes a wiper blade on driver seat side, a wiper blade on passenger seat side, a drive unit on driver seat side that causes wiper blade on driver seat side to perform tandem operation, and a drive unit on passenger seat side that causes wiper blade on passenger seat side to perform tandem operation. The drive units on driver and passenger seat sides transmit and receive drive information. An operation range of wiper blade on passenger seat side is set narrower and closer to an upper inversion position side than an operation range of wiper blade on driver seat side. The drive unit on passenger seat side changes operation range of wiper blade on passenger seat side toward a lower inversion position side of wiper blade on driver seat side in response to detecting, based on drive information, a failure of drive unit on driver seat side.

### CROSS-REFERENCE TO RELATED APPLICATION

This application claims the priority benefits of Japanese application no. 2024-103948, filed on Jun. 27, 2024. The entirety of the above-mentioned patent application is hereby incorporated by reference herein and made a part of this specification.

### BACKGROUND

### Technical Field

The disclosure relates to a wiper device.

### Related Art

In the following Patent Document 1 (Japanese Patent Application Laid-Open Publication No. 2016-088320), an opposite type wiper device is disclosed that suppresses interference between wiper blades without impairing the appearance of wiper operation. This wiper device sets the operation range of the wiper blade on passenger seat side narrower than the operation range of the wiper blade on driver seat side and sets it to a range that overlaps only slightly with the operation range of the wiper blade on driver seat side, sets the lower inversion position of the wiper blade on passenger seat side in the vicinity of the outer edge of the operation range of the wiper blade on driver seat side, forms an overlapping operation range between the two operation ranges, sets the normal stop position of the wiper blade on passenger seat side when the wiper system is not operating to the upper inversion position side, and a pair of wiper blades perform tandem operation during reciprocating wiping operation while being arranged in opposite configuration.

### CITATION LIST

### Patent Document

[Patent Document 1] Japanese Patent Application Laid-Open Publication No. 2016-088320

However, in such a wiper device, the operation range of the wiper blade on passenger seat side is set narrower and closer to the upper inversion position side than the operation range of the wiper blade on driver seat side, and is set to a range that overlaps only slightly with the operation range of the wiper blade on driver seat side. Therefore, for example, in the case of a failure of the wiper motor on driver seat side, since the operation range of the wiper blade on passenger seat side is positioned away from the driver seat, there is a problem that it is difficult to secure the driver's field of vision.

The disclosure has been made in view of the above circumstances, and aims to provide a wiper device capable of easily securing the driver's field of vision even in the case that the operation range of the wiper blade on passenger seat side is narrower and closer to the upper inversion position side than the operation range of the wiper blade on driver seat side.

### SUMMARY

A wiper device includes a wiper blade on driver seat side; a wiper blade on passenger seat side; a drive unit on the driver seat side that causes the wiper blade on the driver seat side to perform tandem operation; and a drive unit on the passenger seat side that causes the wiper blade on the passenger seat side to perform tandem operation. The drive unit on the driver seat side and the drive unit on the passenger seat side transmit and receive drive information. An operation range of the wiper blade on the passenger seat side is set narrower and closer to an upper inversion position side of the wiper blade on the passenger seat side than an operation range of the wiper blade on the driver seat side. The drive unit on the passenger seat side changes the operation range of the wiper blade on the passenger seat side toward a lower inversion position side of the wiper blade on the driver seat side in response to detecting, based on the drive information, a failure of the drive unit on the driver seat side.

### BRIEF DESCRIPTION OF THE DRAWINGS

FIG. 1 is a schematic diagram showing wiper blades of a wiper device A according to an embodiment of the disclosure.

FIG. 2 is a block diagram showing the electrical connection relationship of the wiper device A according to an embodiment of the disclosure.

FIG. 3 is a flowchart showing the operation of the wiper device A according to an embodiment of the disclosure.

FIG. 4 is a schematic diagram showing the change of the wiping range (operation range) in an embodiment of the disclosure.

### DESCRIPTION OF THE EMBODIMENTS

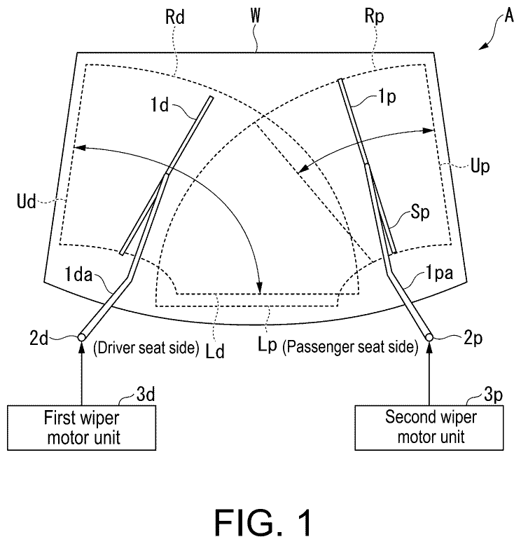

An embodiment of the disclosure will be described with reference to FIG. 1 to FIG. 4. A wiper device A according to the embodiment is a device mounted on various types of vehicles such as gasoline vehicles, hybrid vehicles or electric vehicles, and that wipes rainwater attached to the surface (wiped surface) of a wiped member such as a front glass or rear glass etc.

This wiper device A causes a pair of wiper blades placed near the center of a front glass W to perform tandem operation (parallel linked operation) as shown in FIG. 1 and FIG. 4. A pair of wiper blades 1d, 1p are rod-shaped members placed on the front glass W as shown. The pair of wiper blades 1d, 1p are in contact with a surface (wiped surface) of the front glass W (wiped member), and wipe away rainwater and insects etc. attached to the front glass W by reciprocating motion on the wiped surface. The pair of wiper blades 1d, 1p are attached to one end of wiper arms 1da, 1pa at the center of their respective longitudinal direction.

In FIG. 1 and FIG. 4, reference numeral Rd is a wiping range (operation range) of the wiper blade 1d on driver seat side, and reference numeral Rp is a wiping range (operation range) of the wiper blade 1p on passenger seat side. The wiping range Rd on driver seat side is a movement range of the wiper blade 1d on driver seat side with a wiper shaft 2d on driver seat side as a rotation center, and is a fan-shaped range spanning from a lower inversion position Ld to an upper inversion position Ud of the wiper blade 1d on driver seat side.

In contrast, the wiping range Rp on passenger seat side is a movement range of the wiper blade 1p on passenger seat side with a wiper shaft 2p on passenger seat side as a rotation center, and is a fan-shaped range spanning from a lower inversion position Lp to an upper inversion position Up of the wiper blade 1p on passenger seat side. The wiper blade 1p on passenger seat side is at a position Sp (stop position) shown in the figure when not operating, but when the wiping operation starts, it reciprocates within the wiping range Rp set narrowly from the stop position Sp toward the upper inversion position Up side. That is, the wiping range Rp on passenger seat side is biased toward the upper inversion position Up on passenger seat side and is set to a narrower range (narrow wiping range) than the wiping range Rd on driver seat side.

The pair of wiper blades 1d, 1p temporarily stop at the lower inversion positions Ld, Lp and the upper inversion positions Ud, Up during reciprocating motion in the wiping ranges Rd, Rp. Specifically, when the pair of wiper blades 1d, 1p move from the lower inversion positions Ld, Lp toward the upper inversion positions Ud, Up, they temporarily stop at the upper inversion positions Ud, Up, and after the stop, move from the upper inversion positions Ud, Up toward the lower inversion positions Ld, Lp.

Moreover, the pair of wiper blades 1d, 1p temporarily stop at the lower inversion positions Ld, Lp, and after the stop, move from the lower inversion positions Ld, Lp toward the upper inversion positions Ud, Up. That is, the pair of wiper blades 1d, 1p in this embodiment repeat reciprocating motion while temporarily stopping at the lower inversion positions Ld, Lp and the upper inversion positions Ud, Up.

Such a wiper device A includes, as shown in FIG. 1 and FIG. 4, a first wiper motor unit 3d and a second wiper motor unit 3p that individually drive the pair of wiper blades 1d, 1p. Of these first wiper motor unit 3d and second wiper motor unit 3p, the first wiper motor unit 3d corresponds to the drive unit on driver seat side in the disclosure, and the second wiper motor unit 3p corresponds to the drive unit on passenger seat side in the disclosure.

The first wiper motor unit 3d and the second wiper motor unit 3p are drive units that individually drive the pair of wiper blades 1d, 1p, and also make the pair of wiper blades 1d, 1p perform tandem operation (parallel linked operation). That is, the first wiper motor unit 3d (drive unit on driver seat side) makes the wiper blade 1d on driver seat side perform tandem operation, and the second wiper motor unit 3p makes the wiper blade 1p on passenger seat side perform tandem operation.

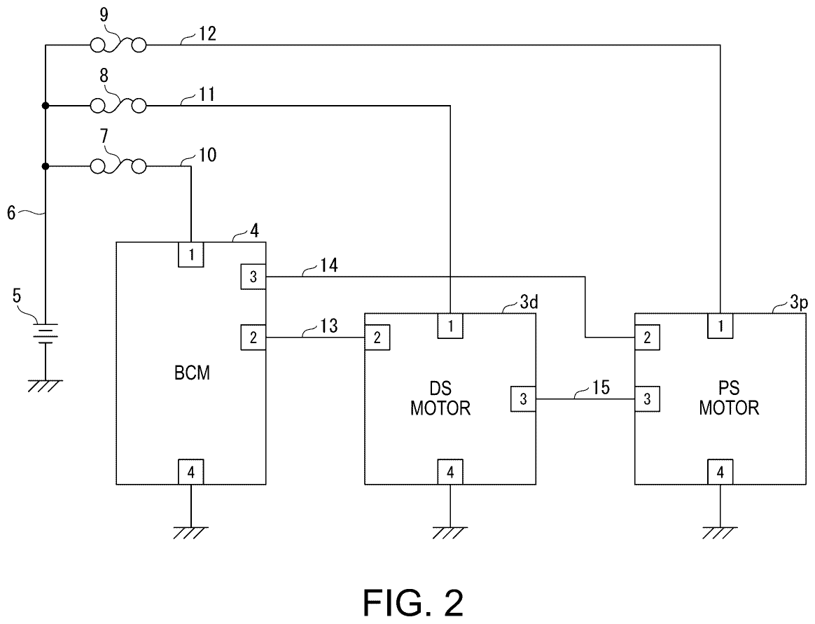

Such a wiper device A includes a wiring structure shown in FIG. 2. That is, when viewed as a wiring structure, the wiper device A includes, in addition to the first wiper motor unit 3d (DSMOTOR) and the second wiper motor unit 3p (PSMOTOR), a control unit 4 (BCM), a vehicle battery 5, a main power cable 6, three fuses 7-9, three branch power cables 10-12, a first communication cable 13, a second communication cable 14, and a third communication cable 15.

Moreover, the first wiper motor unit 3d (DSMOTOR) and the second wiper motor unit 3p (PSMOTOR) each include, as shown in FIG. 2, a first terminal, a second terminal, a third terminal, and a fourth terminal as functional parts related to the wiring structure. These first terminal, second terminal, third terminal, and fourth terminal are all connection terminals.

The control unit 4 (BCM), as shown, includes a first terminal, a second terminal, a third terminal, and a fourth terminal as connection terminals. This control unit 4 (BCM) has its first terminal connected to a first branch power cable 10. Moreover, the control unit 4 (BCM) has its second terminal connected to the second terminal of the first wiper motor unit 3d via the first communication cable 13.

Moreover, the control unit 4 (BCM) has its third terminal connected to the second terminal of the second wiper motor unit 3p via the second communication cable 14. Furthermore, this control unit 4 (BCM) has its fourth terminal connected to a reference potential (GND). This control unit 4 (BCM) controls the first wiper motor unit 3d and the second wiper motor unit 3p by outputting predetermined control signals from the second terminal and the third terminal.

The vehicle battery 5, as shown, has its positive electrode connected to one end of the main power cable 6, and its negative electrode connected to the reference potential (GND). This vehicle battery 5 is a main power supply (voltage source) of the vehicle that outputs DC power at a predetermined voltage, and supplies DC power to the first wiper motor unit 3d, the second wiper motor unit 3p, and the control unit 4 via the main power cable 6, the three fuses 7-9, and the three branch power cables 10-12.

The main power cable 6, as shown, has one end connected to the positive electrode of the vehicle battery 5, and the other end commonly connected to one end of each of the three branch power cables 10-12. The main power cable 6 transmits DC power supplied from the positive terminal of the vehicle battery 5 to the three branch power cables 10-12.

Among the three fuses 7-9, the first fuse 7 is provided at an intermediate part of the first branch power cable 10 as shown. The first fuse 7 has one end connected to the other end side of the main power cable 6, and the other end connected to the first terminal side of the control unit 4. This first fuse 7 melts and cuts off the supply of DC power to the control unit 4 in response to an abnormally large current flowing through the first branch power cable 10.

The second fuse 8 is provided at an intermediate part of the second branch power cable 11 as shown. The second fuse 8 has one end connected to the other end side of the main power cable 6, and the other end connected to the first terminal side of the first wiper motor unit 3d. This second fuse 8 melts and cuts off the supply of DC power to the first wiper motor unit 3d in response to an abnormally large current flowing through the second branch power cable 11.

The third fuse 9 is provided at an intermediate part of the third branch power cable 12 as shown. The third fuse 9 has one end connected to the other end side of the main power cable 6, and the other end connected to the first terminal side of the second wiper motor unit 3p. This third fuse 9 melts and cuts off the supply of DC power to the second wiper motor unit 3p in response to an abnormally large current flowing through the third branch power cable 12.

Among the three branch power cables 10-12, the first branch power cable 10 has one end connected to the other end of the power cable 6, and the other end connected to the first terminal of the control unit 4. The first branch power cable 10 is a power line for supplying DC power output from the vehicle battery 5 to the control unit 4.

The second branch power cable 11 has one end connected to the other end of the power cable 6, and the other end connected to the first terminal of the first wiper motor unit 3d. The second branch power cable 11 is a power line for supplying DC power output from the vehicle battery 5 to the first wiper motor unit 3d.

The third branch power cable 12 has one end connected to the other end of the power cable 6, and the other end connected to the first terminal of the second wiper motor unit 3p. The third branch power cable 12 is a power line for supplying DC power output from the vehicle battery 5 to the second wiper motor unit 3p.

The first communication cable 13, as shown, has one end connected to the second terminal of the control unit 4, and the other end connected to the second terminal of the first wiper motor unit 3d. The first communication cable 13 is a signal line that mediates wired communication between the control unit 4 and the first wiper motor unit 3d, and transmits communication signals of a first method.

The above-mentioned first method is, for example, an automotive LAN (Local Area Network). That is, the control unit 4 and the second wiper motor unit 3p transmit and receive communication signals compliant with the automotive LAN, namely LIN signals, via the first communication cable 13.

The second communication cable 14 has one end connected to the third terminal of the control unit 4, and the other end connected to the second terminal of the second wiper motor unit 3p. The second communication cable 14 is a signal line that mediates wired communication between the control unit 4 and the second wiper motor unit 3p, and transmits communication signals of the first method similar to the first communication cable 13.

That is, the control unit 4 and the second wiper motor unit 3p, similar to the control unit 4 and the first wiper motor unit 3d, transmit and receive LIN signals compliant with the automotive LAN (Local Area Network) via the second communication cable 14. Incidentally, such first communication cable 13 and second communication cable 14 are a first normal communication line and a second normal communication line in this embodiment.

The third communication cable 15 has one end connected to the third terminal of the first wiper motor unit 3d, and the other end connected to the third terminal of the second wiper motor unit 3p. The third communication cable 15 is a signal line that mediates wired communication between the first wiper motor unit 3d and the second wiper motor unit 3p, and transmits communication signals of a second method (CLN signal) different from the first method.

Incidentally, the wired communication between the first wiper motor unit 3d and the second wiper motor unit 3p using the third communication cable 15 is performed only in the case of an abnormality occurring in the wired communication using the first communication cable 13 between the control unit 4 and the first wiper motor unit 3d, or in the wired communication using the second communication cable 14 between the control unit 4 and the second wiper motor unit 3p.

That is, the wiper device A, in the normal state, causes the pair of wiper blades 1d, 1p to perform reciprocating motion based on the wired communication compliant with the automotive LAN between the control unit 4 and the first wiper motor unit 3d, and the wired communication compliant with the automotive LAN between the control unit 4 and the second wiper motor unit 3p.

Such third communication cable 15 is a communication cable that directly connects the first wiper motor unit 3d and the second wiper motor unit 3p. The above-mentioned second method is a communication method different from the automotive LAN. The first wiper motor unit 3d and the second wiper motor unit 3p, by using the third communication cable 15, mutually transmit and receive as drive information the information necessary for synchronized rotation of the pair of wiper shafts 2d, 2p, that is, synchronized drive of the pair of wiper blades 1d, 1p, and information related to their own failures.

Here, the detailed configuration of the first wiper motor unit 3d, the second wiper motor unit 3p, and the control unit 4 will be described. The first wiper motor unit 3d and the second wiper motor unit 3p each include a motor (power source), a drive control circuit, and a communication circuit.

That is, the first wiper motor unit 3d includes: a first motor that rotationally drives the wiper shaft 2d on driver seat side, a first drive circuit that outputs a drive signal to the first motor, and a first communication circuit that outputs a control signal to the first drive circuit by performing wired communication with the control unit 4.

On the other hand, the second wiper motor unit 3p includes: a second motor that rotationally drives the wiper shaft 2p on passenger seat side, a second drive circuit that outputs a drive signal to the second motor, and a second communication circuit that outputs a control signal to the second drive circuit by performing wired communication with the control unit 4.

Such first wiper motor unit 3d and second wiper motor unit 3p rotate the pair of wiper shafts 2d, 2p based on the control signals received from the control unit 4. That is, the first wiper motor unit 3d and the second wiper motor unit 3p cause the pair of wiper blades 1d, 1p to perform reciprocating motion on the surface (wiped surface) of the front glass W by synchronously rotating the pair of wiper shafts 2d, 2p at a predetermined rotation speed.

Moreover, the control unit 4 is, for example, a one-chip microcomputer, and includes at least a memory part, an operation part, and a communication part as functional components. The memory part stores a predetermined wiper control program (application program) in advance. The operation part generates control signals by executing the wiper control program. The communication part transmits the control signals to the first wiper motor unit 3d and the second wiper motor unit 3p.

That is, the control unit 4 is a software control device that synchronously controls the first wiper motor unit 3d and the second wiper motor unit 3p through the cooperation of hardware resources and software resources. This control unit 4 controls the reciprocating motion of the pair of wiper blades 1d, 1p, that is, the wiping operation of the surface (wiped surface) of the front glass W, by synchronously controlling the first wiper motor unit 3d and the second wiper motor unit 3p.

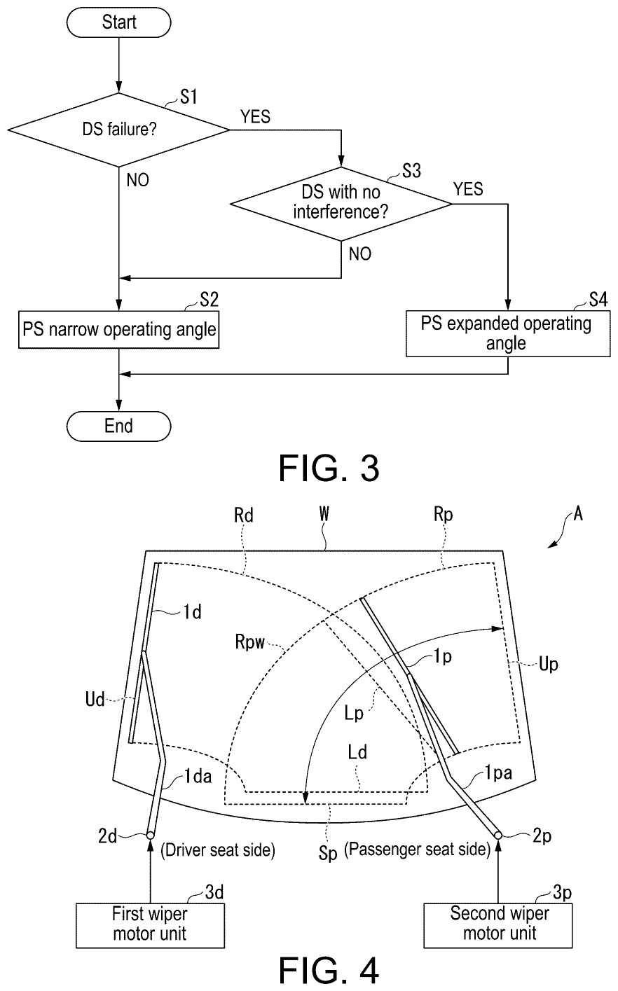

Next, the operation of the wiper device A according to the embodiment will be described in detail with reference to FIG. 3 and FIG. 4.

First, the normal operation of the wiper device A according to the embodiment will be described. In normal operation, this wiper device A has the first wiper motor unit 3d (drive unit on driver seat side) perform tandem operation of the wiper blade 1d on driver seat side, and the second wiper motor unit 3p perform tandem operation of the wiper blade 1p on passenger seat side.

Such tandem operation of the wiper blade 1d on driver seat side and the wiper blade 1p on passenger seat side is realized through wired communication compliant with automotive LAN between the control unit 4 and the first wiper motor unit 3d, and wired communication compliant with automotive LAN between the control unit 4 and the second wiper motor unit 3p.

That is, in normal operation, the wiper device A performs wiping operation on the surface (wiped surface) of the front glass W by sharing drive information through wired communication between the control unit 4 and the first wiper motor unit 3d using the first communication cable 13, and wired communication between the control unit 4 and the second wiper motor unit 3p using the second communication cable 14.

More specifically, the control unit 4 transmits control signals to the first wiper motor unit 3d via the first communication cable 13. Moreover, the control unit 4 transmits control signals to the second wiper motor unit 3p via the second communication cable 14. By supplying control signals from the control unit 4 to the first wiper motor unit 3d and the second wiper motor unit 3p respectively, the first wiper motor unit 3d and the second wiper motor unit 3p synchronously drive the pair of wiper blades 1d, 1p.

By this synchronized drive, the pair of wiper blades 1d, 1p reciprocate in a synchronized state on the surface (wiped surface) of the front glass W. Moreover, by the reciprocating motion of this pair of wiper blades 1d, 1p, rainwater etc. attached to the surface (wiped surface) of the front glass W is wiped off from the wiped surface.

On the other hand, through sharing of drive information in normal operation, the first wiper motor unit 3d and the second wiper motor unit 3p periodically monitor each other's integrity. That is, the first wiper motor unit 3d monitors the integrity of the second wiper motor unit 3p based on the drive information of the second wiper motor unit 3p, and the second wiper motor unit 3p monitors the integrity of the first wiper motor unit 3d based on the drive information of the first wiper motor unit 3d.

For example, the second wiper motor unit 3p determines whether a failure has occurred in the first wiper motor unit 3d based on the drive information of the first wiper motor unit 3d (step S1). And, in the case that the determination in step S1 is “No”, that is, in the case that the first wiper motor unit 3d is normal, the second wiper motor unit 3p maintains the operating angle (PS operating angle) of the wiper blade 1p on passenger seat side as the narrow operating angle (PS narrow operating angle) corresponding to the wiping range Rp on passenger seat side (narrow wiping range) (step S2).

In contrast, in the case that the determination in step S1 is “Yes”, that is, in the case that the first wiper motor unit 3d has failed, the second wiper motor unit 3p determines whether the wiper blade 1p on passenger seat side interferes with the wiper blade 1d on driver seat side (step S3).

That is, the second wiper motor unit 3p determines, based on the drive information last received from the first wiper motor unit 3d, whether the wiper blade 1d on driver seat side, which has stopped operating due to the failure of the first wiper motor unit 3d, exists between the lower inversion position Lp and the stop position Sp of the wiper blade 1p on passenger seat side.

Then, in the case that the determination in step S3 is “No”, that is, in the case that the wiper blade 1d on driver seat side exists between the lower inversion position Lp and the stop position Sp of the wiper blade 1p on passenger seat side, the second wiper motor unit 3p maintains the operating angle (PS operating angle) of the wiper blade 1p on passenger seat side as the narrow operating angle (PS narrow operating angle) corresponding to the wiping range Rp on passenger seat side (narrow wiping range) (step S2).

On the other hand, in the case that the determination in step S3 is “Yes”, that is, in the case that the wiper blade 1d on driver seat side does not exist between the lower inversion position Lp and the stop position Sp of the wiper blade 1p on passenger seat side, the second wiper motor unit 3p sets the operating angle (PS operating angle) of the wiper blade 1p on passenger seat side to an expanded operating angle (PS expanded operating angle) corresponding to an expanded wiping range Rpw on passenger seat side (step S4).

That is, as shown by the arrow in FIG. 4, the second wiper motor unit 3p changes the wiping range Rp on passenger seat side to the expanded wiping range Rpw by moving the lower inversion position Lp in the wiping range Rp on passenger seat side toward the lower inversion position Ld of the wiper blade 1d on driver seat side. This expanded wiping range Rpw is one that changes the wiping range Rp on passenger seat side toward the lower inversion position Lp side of the wiper blade 1p on passenger seat side.

Such a wiper device A includes a wiper blade 1d on driver seat side, a wiper blade 1p on passenger seat side, a first wiper motor unit 3d (drive unit on driver seat side) that causes the wiper blade 1d on driver seat side to perform tandem operation, and a second wiper motor unit 3p (drive unit on passenger seat side) that causes the wiper blade 1p on passenger seat side to perform tandem operation, wherein the first wiper motor unit 3d (drive unit on driver seat side) and the second wiper motor unit 3p (drive unit on passenger seat side) transmit and receive drive information with each other, and the operation range of the wiper blade 1p on passenger seat side is set narrower and closer to the upper inversion position Up side of the wiper blade 1p on passenger seat side than the operation range of the wiper blade 1d on driver seat side, and the second wiper motor unit 3p (drive unit on passenger seat side), in response to detecting a failure of the first wiper motor unit 3d (drive unit on driver seat side) based on the drive information, changes the operation range of the wiper blade 1p on passenger seat side toward the lower inversion position Ld side of the wiper blade 1d on driver seat side.

According to this embodiment, since the operation range of the wiper blade 1p on passenger seat side is changed toward the lower inversion position Ld side of the wiper blade 1d on driver seat side in the case of a failure of the first wiper motor unit 3d (drive unit on driver seat side), it is possible to provide a wiper device A capable of easily securing the driver's field of vision.

Moreover, in the wiper device A according to this embodiment, the second wiper motor unit 3p (drive unit on passenger seat side) changes the operation range of the wiper blade 1p on passenger seat side toward the lower inversion position side of the wiper blade 1d on driver seat side in the case of detecting, based on the drive information of the first wiper motor unit 3d (drive unit on driver seat side), that the wiper blade 1p on passenger seat side does not interfere with the wiper blade 1d on driver seat side.

According to this embodiment, after allowing or disallowing interference between the wiper blade 1p on passenger seat side and the wiper blade 1d on driver seat side, it is possible to secure the driver's field of vision by changing the operation range of the wiper blade 1p on passenger seat side toward the lower inversion position Ld side of the wiper blade 1d on driver seat side.

Moreover, in the wiper device A according to this embodiment, the second wiper motor unit 3p (drive unit on passenger seat side) expands the operation range of the wiper blade 1p on passenger seat side toward the lower inversion position Ld side of the wiper blade 1d on driver seat side by moving the lower inversion position Lp of the wiper blade 1p on passenger seat side toward the lower inversion position Ld side of the wiper blade 1d on driver seat side without changing the upper inversion position Up of the wiper blade 1p on passenger seat side.

According to this embodiment, since only the lower inversion position Lp of the wiper blade 1p on passenger seat side is moved toward the lower inversion position Ld side of the wiper blade 1d on driver seat side to secure the driver's field of vision, the change in the operation range of the wiper blade 1p on passenger seat side is easy.

Moreover, in the wiper device A according to this embodiment, the first wiper motor unit 3d (drive unit on driver seat side) and the second wiper motor unit 3p (drive unit on passenger seat side) are directly connected by the third communication cable 15, and transmit and receive drive information through the third communication cable 15. According to this embodiment, it is easy to obtain drive information in the case of a failure of the first wiper motor unit 3d (drive unit on driver seat side).

Furthermore, in the wiper device A according to this embodiment, the wiper blade 1d on driver seat side and the wiper blade 1p on passenger seat side are arranged in an opposite configuration. According to this embodiment, in the wiper device A where the wiper blade 1d on driver seat side and the wiper blade 1p on passenger seat side are arranged in an opposite configuration, it is easy to secure the driver's field of vision in the case of a failure of the first wiper motor unit 3d (drive unit on driver seat side).

The disclosure is not limited to the above embodiment, and various modifications are possible. For example, in the above embodiment, the driver's field of vision is secured by expanding the operation range of the wiper blade 1p on passenger seat side by moving the lower inversion position Lp of the wiper blade 1p on passenger seat side to the lower inversion position Ld side of the wiper blade 1d on driver seat side, that is, to the stop position Sp, without changing the upper inversion position Up of the wiper blade 1p on passenger seat side. However, the driver's field of vision may be secured by moving the upper inversion position Up of the wiper blade 1p on passenger seat side in addition to the lower inversion position Lp of the wiper blade 1p on passenger seat side.

As a method for securing the driver's field of vision, for example, in addition to moving the lower inversion position Lp of the wiper blade 1p on passenger seat side to the stop position Sp of the wiper blade 1d on driver seat side, it is possible to move the upper inversion position Up of the wiper blade 1p on passenger seat side to the lower inversion position Lp of the wiper blade 1p on passenger seat side.

That is, the disclosure secures the driver's field of vision by changing the wiping range Rp (narrow wiping range, operation range) of the wiper blade 1p on passenger seat side toward the lower inversion position Ld side of the wiper blade 1d on driver seat side in the case of a failure of the first wiper motor unit 3d (drive unit on driver seat side).

As described above, in the case of moving the lower inversion position Lp of the wiper blade 1p on passenger seat side to the stop position Sp of the wiper blade 1d on driver seat side, and also moving the upper inversion position Up of the wiper blade 1p on passenger seat side to the lower inversion position Lp of the wiper blade 1p on passenger seat side, it is possible to secure the driver's field of vision by sacrificing the field of vision of the passenger in the passenger seat.

What is claimed is:

1. A wiper device, comprising: a wiper blade on driver seat side; a wiper blade on passenger seat side; a drive unit on the driver seat side that causes the wiper blade on the driver seat side to perform tandem operation; and a drive unit on the passenger seat side that causes the wiper blade on the passenger seat side to perform tandem operation, wherein the drive unit on the driver seat side and the drive unit on the passenger seat side transmit and receive drive information, and an operation range of the wiper blade on the passenger seat side is set narrower and closer to an upper inversion position side of the wiper blade on the passenger seat side than an operation range of the wiper blade on the driver seat side,
wherein the drive unit on the passenger seat side changes the operation range of the wiper blade on the passenger seat side toward a lower inversion position side of the wiper blade on the driver seat side in response to detecting, based on the drive information, a failure of the drive unit on the driver seat side.

2. The wiper device according to claim 1, wherein the drive unit on the passenger seat side changes the operation range of the wiper blade on the passenger seat side toward the lower inversion position side of the wiper blade on the driver seat side in response to detecting, based on the drive information, that the wiper blade on the passenger seat side does not interfere with the wiper blade on the driver seat side.

3. The wiper device according to claim 1, wherein the drive unit on the passenger seat side expands the operation range of the wiper blade on the passenger seat side toward the lower inversion position side of the wiper blade on the driver seat side by moving a lower inversion position of the wiper blade on the passenger seat side toward the lower inversion position side of the wiper blade on the driver seat side without changing an upper inversion position of the wiper blade on the passenger seat side.

4. The wiper device according to claim 2, wherein the drive unit on the passenger seat side expands the operation range of the wiper blade on the passenger seat side toward the lower inversion position side of the wiper blade on the driver seat side by moving a lower inversion position of the wiper blade on the passenger seat side toward the lower inversion position side of the wiper blade on the driver seat side without changing an upper inversion position of the wiper blade on the passenger seat side.

5. The wiper device according to claim 1, wherein the drive unit on the driver seat side and the drive unit on the passenger seat side are directly connected by a communication cable, and transmit and receive the drive information through the communication cable.

6. The wiper device according to claim 2, wherein the drive unit on the driver seat side and the drive unit on the passenger seat side are directly connected by a communication cable, and transmit and receive the drive information through the communication cable.
